(19) United States
(12) Patent Application Publication
(10) Pub. No.: US 2010/0229835 A1
(43) Pub. Date: Sep. 16, 2010

(54) NOVELTY IN ELECTRIC FUEL PUMPS FOR INTERNAL COMBUSTION ENGINES

(75) Inventor: Mehmet Feyyaz Tarancioglu, Kemalpasa (TR)

Correspondence Address: AKERMAN SENTERFITT, P.O. BOX 3188, WEST PALM BEACH, FL, 33402-3188, US

(73) Assignee: Superpar Otomotiv Sanayi Ve Ticaret Anonim Sirketi, Kemalpasa (TR)

(21) Appl. No.: 12/597,268

(22) PCT Filed: May 1, 2007
(86) PCT No.: PCT/TR07/00041

§ 371 Date: Mar. 31, 2010

(51) Int. Cl. F02M 37/04

(52) U.S. Cl. 123/497

(57) ABSTRACT

Present invention relates to an electric fuel pump for an internal combustion engine in which a single-phase brushless dc motor is rotatably coupled with a roller vane or other pump mechanism so that any type of fuel or combination of fuels can be transferred from the inlet (2) to the outlet (35) of the unit which houses all above mentioned elements providing lubrication and cooling to the above mentioned elements. The fuel flow path is so designed as to provide better cooling to the commutation circuit (10) by placing the commutation circuit (10) as the first element to come into contact with fresh fuel, directing the fuel flow towards the heat sinks of the commutation circuit (10) and placing the stator coils (36) downstream of the fuel flow so that the heat generated by the stator coils (36) is taken away from the commutation circuit (10).

### TECHNICAL FIELD

The invention relates to the electric fuel pumps for internal combustion engines.

The invention relates particularly to a method and a mechanism for introducing a cheap single-phase brushless dc fuel pump which eliminates the wear problems of the brushed dc systems and the cost problems of the three-phase brushless dc systems.

### BACKGROUND ART

Today, to increase efficiency of the fuel pumps on vehicle, various electric fuel pumps have been manufactured. Electric fuel pumps for internal combustion engines have long been known and used. About internal combustion engines there have been many applications at present, one of these applications is U.S. Pat. No. 5,120,201 A1 numbered patent application and it relates fuel delivery systems for internal combustion engines, and more particularly to a self-contained electric-motor fuel pump for use therein. Particularly said application includes statements as subjacent “A self-contained brushless electric-motor fuel pump for internal combustion engine fuel delivery systems and like applications in accordance with the present invention comprises a housing having a fuel inlet and fuel outlet, and a brushless electric motor with a permanent magnet armature mounted for rotation within the housing and stator windings surrounding the armature within the housing. A pump mechanism is operatively positioned between the fuel inlet and outlet, and is coupled to the armature for corotation with the armature within the housing to pump fuel under pressure from the inlet to the outlet.”

Another application which relates electric fuel pumps is U.S. Pat. No. 4,728,264 numbered patent application and it discloses a fuel delivery system in which a direct current motor fuel pump delivers fuel under pressure from a supply tank to an engine. A pressure sensitive switch, which may be contained within unitary pump/motor housing, is responsive to fuel pump output pressure for applying a pulse width modulated direct current signal to the pump motor, and thereby controlling pump operation so as to maintain constant pressure in the fuel delivery line to the engine independently of fuel demand.

Conventional permanent magnet direct current (PMDC) motors are traditionally designed with relatively inexpensive commutating parts comprising a commutator and a brush system. For many specific applications these brushed dc motors will keep their importance, especially at the lower end of the applications range.

Carbon brushes and copper or graphite commutators wear out due to chemical attack by a variety of alternative fuels or fuel combinations. Higher spring forces applied to the brushes to overcome the effect of engine vibrations cause rapid wearing out of the brushes and commutator. Particles ripped from the brushes and commutator and carried by the fuel to the fuel system cause problems in the ever decreasing injector nozzle diameters of high pressure fuel injectors.

Because of these cases some electric fuel pump manufacturers have launched attempts to design and build brushless dc electric motors to overcome problems associated with the brush/commutator contact wear. EP No 1324474 A2 discloses a brushless direct current motor—and more particularly, but not exclusively such a motor—for use in conjunction with a fuel pump. All attempts so far have remained within a three-phase controller system.

Three-phase controllers are designed and built based on two systems. Systems with sensors require three hall-effect switches in order to be able to detect the rotor position. So called sensorless systems do not use sensors but sophisticated algorithms, which require microprocessors in order to be able to perform the massive mathematical operations required to detect the rotor position. Both systems need to use six power transistors to energize the stator coils in a certain sequence. Therefore using a three-phase motor in a small fuel pump cause cost increase.

The complexity of components and algorithms to control and drive a three-phase motor in a small fuel pump and the cost that has to be paid for this much sophistication has prevented three-phase brushless fuel pump designs to find widespread OEM use. They have remained as fancy aftermarket items addressing motorists, who are seeking state of the art gadgets regardless of the cost.

As a result, the presence of the need of introducing a cheap single-phase brushless dc fuel pump due to many advantages it provides and the insufficiency of the existing solutions have made it necessary to perform an improvement in the relevant technical field.

### SUMMARY OF THE INVENTION

The present invention relates to the electric fuel pumps for internal combustion engines as a method, which fulfills a foresaid requirement, eliminates all the disadvantages and provides some additional advantages.

Based on the state of the background art, the main object of this invention is to eliminate the wear problems of the brushed dc systems and the cost problems of the three-phase brushless dc systems by introducing a cheap single-phase brushless dc fuel pump.

Another object of the invention is to overcome the problems which have limited the use of single-phase brushless systems to air moving devices and make it possible to use them on a more challenging field like fuel pumps.

With this invention it has been made possible to introduce brushless fuel pumps into the engine industry as cheap reliable solutions.

Another object of this invention is to match the life of the inlet filter with the highly extended motor life by introducing a serviceable filter element. The serviceable filter element is used for the first time in the electric fuel pump industry.

Yet another object of this invention is to use an unserviceable secondary filter element inside the fuel pump to catch debris which has managed to pass the serviceable primary filter for a variety of reasons.

By using a serviceable primary filter and an unserviceable secondary filter, it has been made possible to have a very long pump life which is not limited by the filter life and protect precision pump elements against any kind of misuse or abuse.

Yet another object of this invention is to facilitate manufacturing and assembly of the complete unit by designing the driving and driven components in two completely independent subassemblies and clamping them together with an axial movement. The two subassemblies are brought to the same axis and locked to each other by the mating surfaces.

Through clever design and assembly techniques cost has been kept low because cost is as important for manufacturers of OEM equipment as quality.

In order to achieve all the aforesaid advantages, which will also become apparent from the following detailed description, the present invention brings together many conveniences depending on its said features.

The structural and characteristic features and all the advantages of the invention will become clearer from the enclosed drawings and the following detailed description where reference is being made to said drawings, thus the evaluation must be based on these drawings and the detailed description.

### BRIEF DESCRIPTION OF THE DRAWINGS

In order to best understand the embodiment of the present invention and the advantages thereof together with the supplemental elements, it must be considered along with the drawings for which the description is provided herein below.

FIG. 1; is an exploded view of the complete fuel pump.

FIG. 2; is a block diagram of the fuel flow of the current invention.

FIG. 3; is a block diagram of the fuel flow of the prior art.

FIG. 4; is a schematic diagram of a single-phase brushless dc commutation circuit.

FIG. 5; is a schematic diagram of a two-phase brushless dc commutation circuit.

FIG. 6; is a schematic diagram of a three-phase brushless dc commutation circuit.

FIG. 7; is a schematic view of the filter system of the prior art.

FIG. 8; is a schematic view of the filter system of the current invention.

FIG. 9; is an exploded view of the driven subassembly.

FIG. 10; is an exploded view of the driving subassembly.

FIG. 11; is a perspective view of the driven and driving subassemblies prior to final assembly.

FIG. 12 and FIG. 13 are two perspective views of the motor rotor.

### REFERENCE NUMBERS

1. Pump housing
2. Fuel inlet
3. Moulded inlet cover
4. Serviceable primary filter
5. Plug
6. Electrical terminals
7. Electromagnetic interference filter
8. Secondary filter
9. Card housing
   9.1 Openings
10. Commutation circuit
11. Centring
12. Stator moulded insulator
13. Stator
14. Stator end insulator
15. Self tapping screws
16. Retainer
17. Washer
18. Magnet rotor
19. Spacer
20. Torsional spring coupling
21. Moulded coupling
22. Pump element
23. Pump element
24. Pump element (Pump rotor)
25. Pump element
26. Pump element
27. Spring
28. Pressure relief valve
29. Fixed shaft
30. Pump carrier
31. Protrusion
32. Indentations
33. The hole
34. Extension
35. Fuel outlet
36. Stator coil
37. Unserviceable inlet filter

### DETAILED DESCRIPTION OF THE INVENTION

In the following detailed description, the method and mechanism for introducing a cheap single-phase brushless dc fuel pump is explained only to enable better understanding of the subject, without any restricting effect.

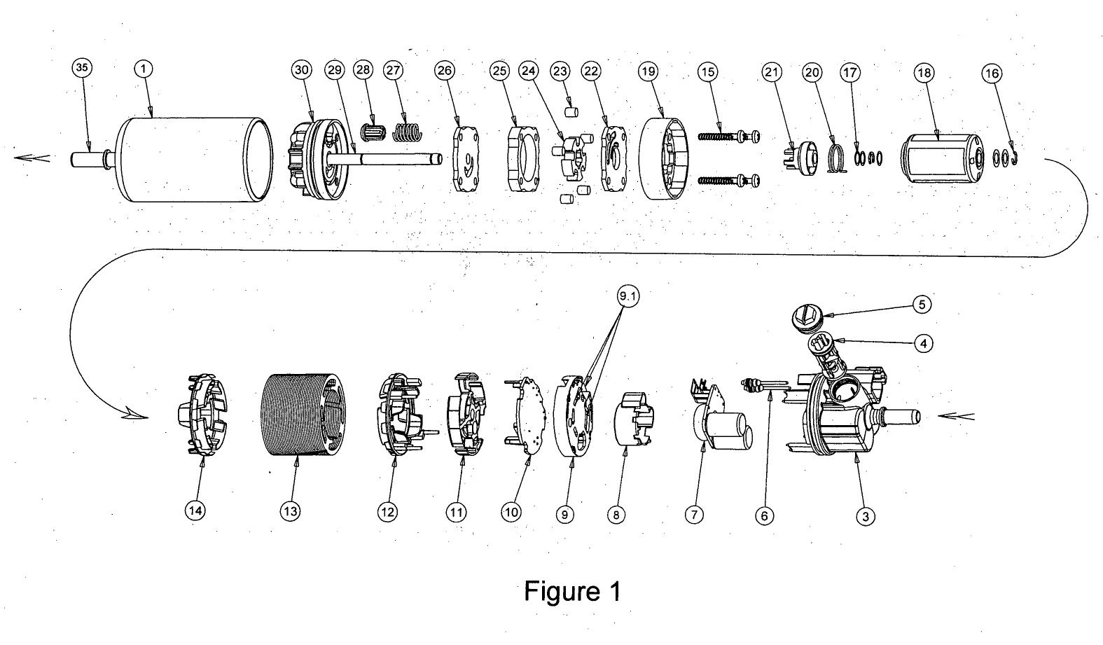

A first preferred embodiment of the fuel pump according to the present invention referring now in detail to the drawings and initially FIG. 1.

In the exploded view of the complete fuel pump shown in FIG. 1, there are a fuel inlet (2), a fuel outlet (35) and all elements which are lubricated and cooled by any type of fuel or combination of fuels transferred from the inlet (2) to the outlet (35). Moulded inlet cover (3) houses, serviceable primary filter (4), plug (5), electrical terminals (6), electromagnetic interference filter (7) and secondary filter (8).

Fuel is drawn into the moulded inlet cover (3) through fuel inlet (2), passes through serviceable primary filter (4), around electromagnetic interference filter (7), and through secondary filter (8). Fuel is then directed towards the heat sinks of the power transistors through a variety of openings (9.1) on circuit housing (9) for an efficient cooling.

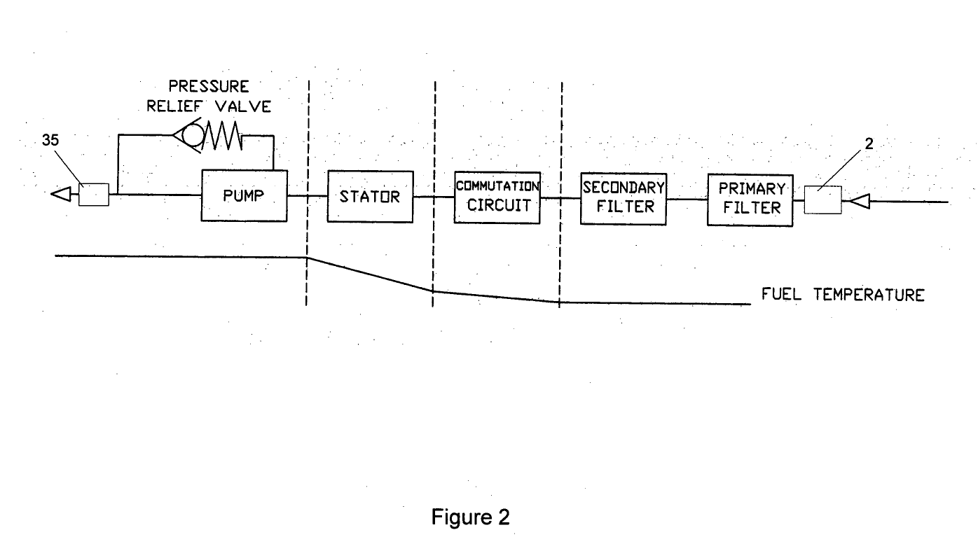

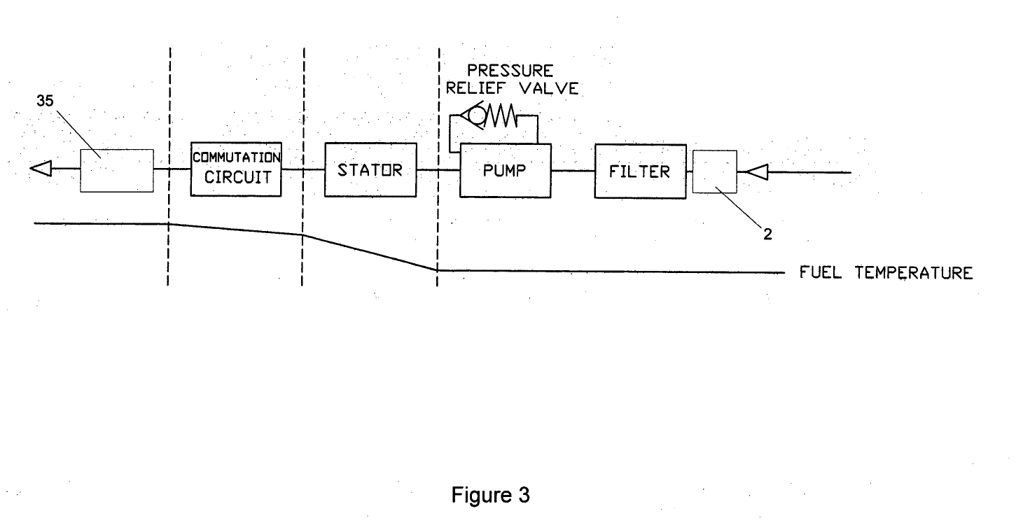

Attention must be drawn to the fuel flow path of the current invention in FIG. 2. Contrary to the fuel flow path of the prior art shown in FIG. 3 where the commutation circuit (10) is downstream of the stator (13) thus coming into contact with fuel heated by the stator coils (36), the fuel flow path in the current invention is so designed as to cool the delicate electronic circuit (10) by the cool incoming fuel first and then directing the fuel into the stator coils (36) which are less prone to high temperature. The clever design of the fuel path of the current invention makes it a superior product over the prior art by increasing the operating temperatures considerably to where it is impossible for the prior art to operate.

Said commutation circuit (10) is not sealed in a hermetic housing but coated with a conformal coating varnish which permits very high heat transfer rate not only from metal heat sinks but also from the electronic components' cases. On the other hand said commutation circuit (10) monitors fuel temperature and responds to subzero temperatures by increasing its power output as the fuel temperature decreases.

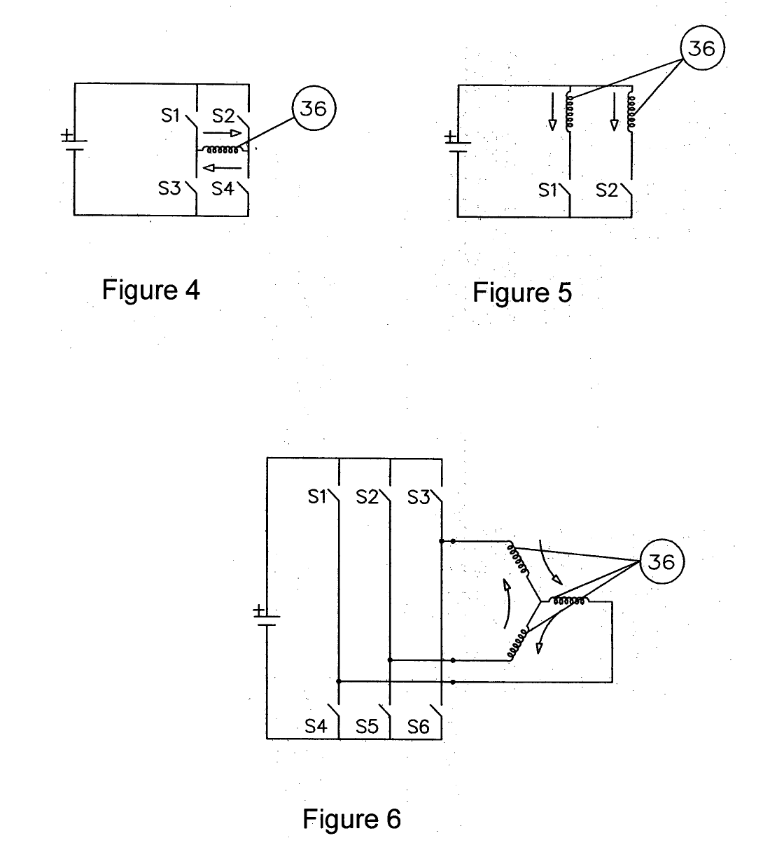

In FIGS. 4,5 and 6 it's shown how single-phase, two-phase and three-phase systems operate respectively. In a single-phase system as in FIG. 4, a single coil (36) is energized in alternative directions. As there is only one coil (36) energized alternately by every driver signal, the power output/copper ratio is highest.

In a two-phase system as shown in FIG. 5, there are two coils (36) wound in opposite directions. These coils (36) are energized alternatively by the commutation circuit (10). In this driving topology, the power output/copper ratio is 1/2 of the single-phase system. As this system requires fewer switches (S1, S2) than the single-phase system, it is preferred for very low power densities where power output/copper ratio is negligible.

In a three-phase system as shown in FIG. 6, two of the three coils (36) are energized at a time, thus making the power output/copper ratio 2/3 of the single-phase system. As three phase systems require 6 switches (S1, S2, S3, S4, S5, S6) to operate they are preferred for bidirectional applications where switching cost is justified by the application.

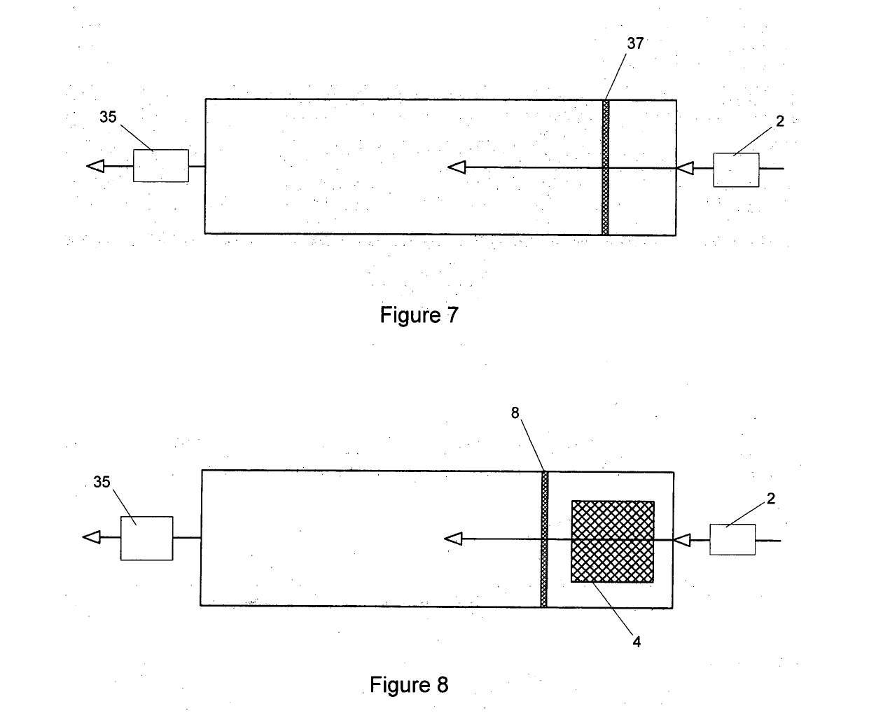

FIG. 7 shows the filter system of the prior art. In the prior art fuel passes through an unserviceable filter (37) before going through the other pump elements (22, 23, 24, 25, 26). This filter (37), because it cannot be cleaned or replaced, determines the life of the pump. When the filter (37) is blocked due to incoming debris, the pump can not suck fuel anymore from the system and there is no cure for this. This ends the life of the said pump.

FIG. 8 shows the filter system of the current invention. Contrary to the prior art, the inlet filter (4) can be cleaned or replaced when it is blocked by debris. Furthermore, a secondary filter (8) which is placed immediately after the primary filter (4) downstream of the fuel flow makes sure that no debris can creep into the pump during the servicing of the said primary filter (4). As the secondary filter (8) is unreachable by the end user it is impossible to remove it thus making it a vital element for the protection of the pump from mishandling.

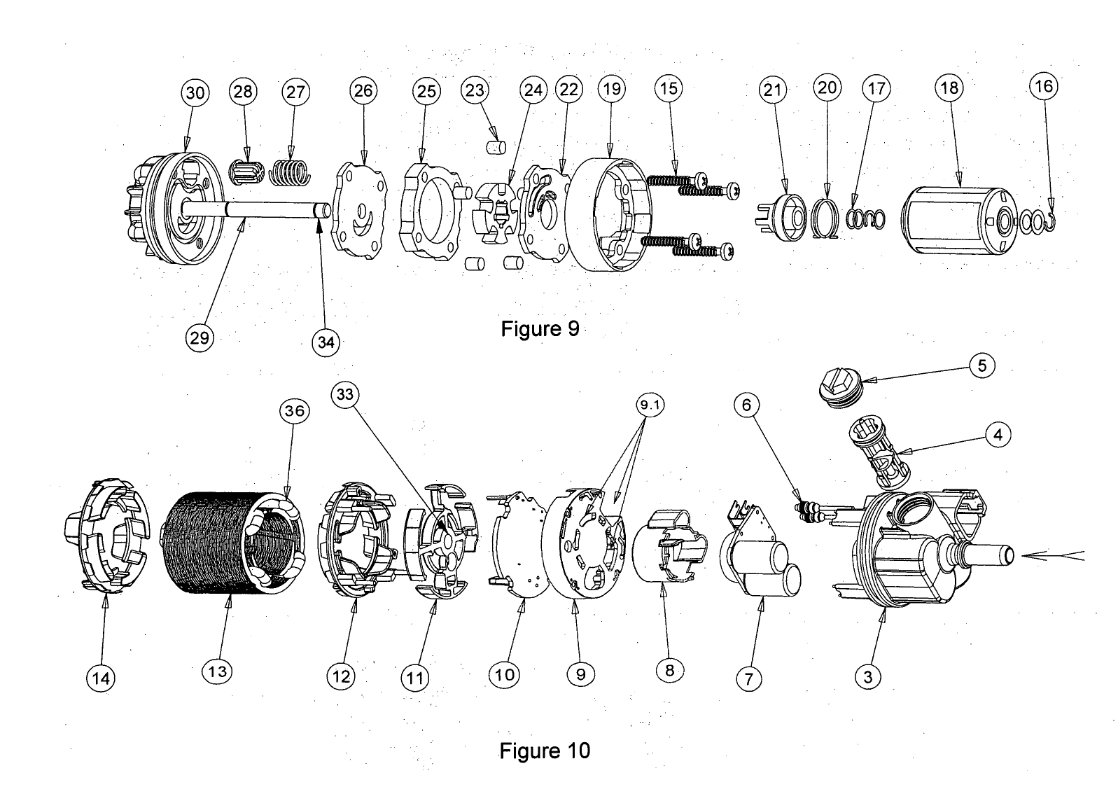

In a preferred driven subassembly shown in FIG. 9, a moulded pump carrier (30), has a moulded-in shaft (29). Pump elements (22, 23, 24, 25, 26) and spacer (19) are assembled on the pump carrier (30) and tightened by four self tapping screws (15).

Couplings (20, 21) rotatably connect the pump rotor (24) with the magnet rotor (18) on the same fixed shaft (29) to give the magnetic rotor (18) a certain amount of angular backlash so that the magnetic rotor (18) can start against a lower torque under severe conditions like cold jelly fuel or trapped foreign material inside the pump mechanism that requires a higher torque to overcome. Said torsional spring coupling (20) rotatably connecting the magnetic rotor (18) with the pump rotor (24) to recoil when the pump is de-energized thus preparing the said components for the next successful start with backlash and to force the magnetic rotor rotatably backwards towards a position where further successful starts are more likely than a random position. Washers (17) and retainer (16) axially fix all the rotating components on fixed shaft (29).

In the same preferred subassembly, the rotor (24) of the roller vane or other pump is rotatably connected with the rotor (18) of the electric motor by two couplings (20,21). A moulded coupling (21) which has a plurality of extensions is rotatably connected with the pump rotor (24). A torsion spring coupling (20) with formed ends rotatably connects the moulded coupling (21) to the motor rotor (18), so that a flexible torque transmission is obtained.

In a preferred driving subassembly shown in FIG. 10, the moulded inlet cover (3) is ultrasonically welded to the card housing (9) whereas the card housing (9) is ultrasonically welded to the stator moulded insulator (12) thus forming a rigid block with the stator (13). Centring (11) is placed between the stator moulded insulator (12) and card housing (9) before the two are welded together.

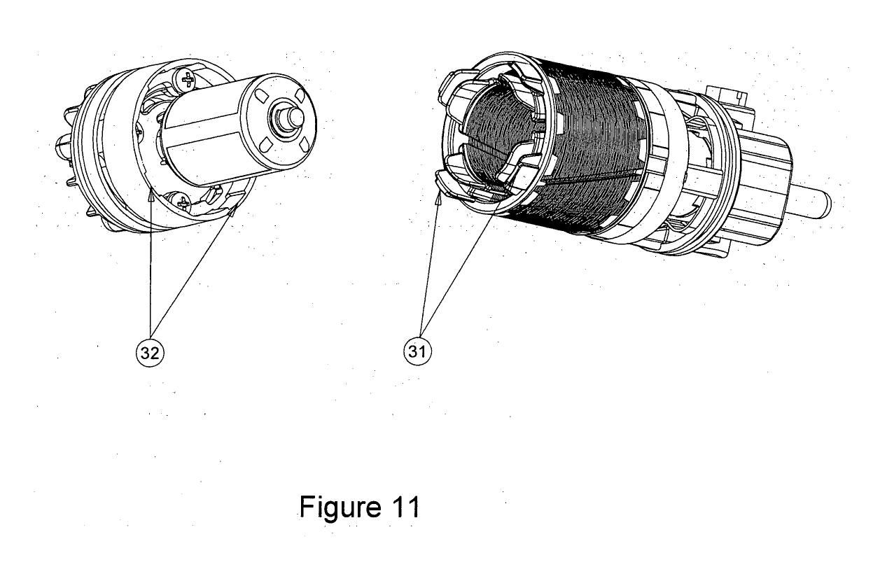

A preferred assembly of the driving and driven subassemblies shown in FIG. 11 makes use of four cleverly designed protrusions (31) on the stator end insulator (14) of the driving assembly and four indentations (32) on the spacer (19) of the driven assembly to make sure that the two subassemblies are assembled concentrically forming a uniform air gap between stator (13) and rotor (18).

Another preferred assembly of the driving and driven subassemblies makes use of the four protrusions (31) on the stator end insulator (14) and four indentations (32) on the spacer (19) to make sure that the torque between the driving and driven assemblies is met and the two assemblies are prevented from rotating in relation to one another.

Another preferred assembly of the present invention, protrusions (31) and indentations (32) may have different shapes or they may be on opposite parts (protrusions (31) on the spacer (19) and indentations (32) on the stator end insulator (14)).

Another preferred assembly of the driving and driven assemblies makes use of the hole (33) of the centring (11) in FIG. 10 to fix the free end of the fixed shaft (29) in FIG. 9 by the extension (34) of the same. When the driving and driven subassemblies are assembled together it is guaranteed that the air gap throughout the whole rotor (18) and stator (13) length is uniform.

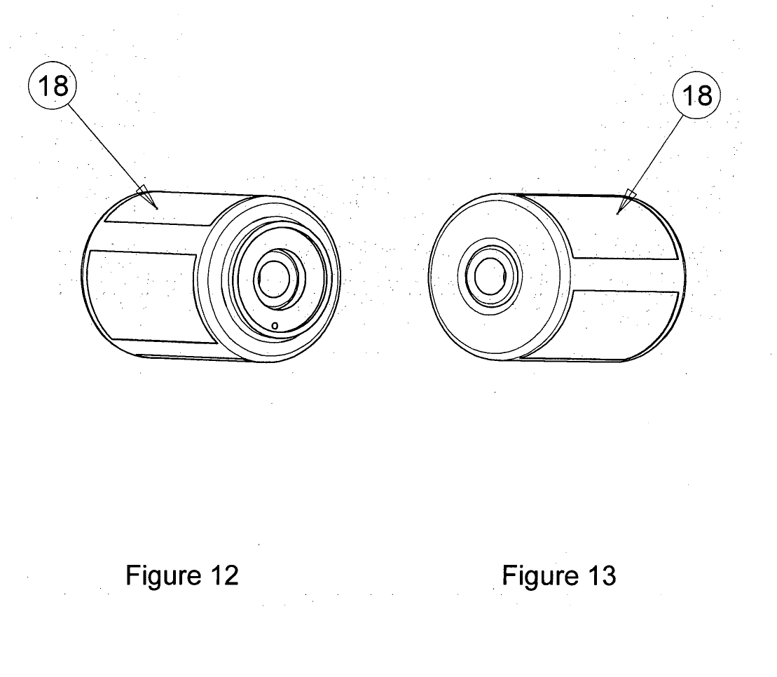

Furthermore, FIG. 12 and FIG. 13 are two perspective views of the magnet rotor (18) from different angles. The magnet rotor (18) is built with four magnets placed in an equiangular pattern around a laminated steel core and overmoulded with an engineering plastic which holds all elements together. The preferred overmoulded plastic is so designed that the magnets and plastic overmoulding form an excellent rotary part which has no protrusions or indentations on the outside very similar to an egg. By adopting an egg-like external form the resistance of the fuel on the rotary motion of the magnet rotor (18) under cold jelly conditions has been totally eliminated.

The protective scope of the present application is determined in the part of claims and the scope may by no means be limited to the description above provided only by way of example. It is obvious that a person skilled in the art may also provide the innovative step of the invention using the similar embodiments and/or applies this embodiment to other fields with similar purpose used in the relevant art. Consequently, such embodiments would obviously lack the criteria of innovative step and particularly, exceeding the known state of the art.

1. An electric fuel pump for an internal combustion engine comprising:
a pump housing;
a pump carrier;
a fixed shaft on which all the rotating components are fixed;
a rotor;
a stator having a winding of stator coils; and
a commutation circuit which energize the stator coils,
wherein the fuel pump comprises at least a single-phase brushless direct current motor rotatably connected with a roller vane or other pump mechanism, which has said rotor in a driven subassembly and said stator in a driving subassembly part of the whole mechanism.

2. The electric fuel pump for an internal combustion engine according to claim 1, wherein said commutation circuit is placed upstream of the stator coils making it possible for cold incoming fuel to make a more efficient cooling of the commutation circuit and taking the heat generated by said stator coils away from the commutation circuit.

3. The electric fuel pump for an internal combustion engine according to claim 1, wherein said commutation circuit is coated with a conformal coating varnish which permits very high heat transfer rate not only from metal heat sinks but also from the electronic components' cases.

4. The electric fuel pump for an internal combustion engine according to claim 1, wherein said single-phase commutation circuit monitors fuel temperature and responds to subzero temperatures by increasing its power output as the fuel temperature decreases.

5. The electric fuel pump for an internal combustion engine according to claim 1, wherein in said stator winding, all winding wire mass is energized in every commutation phase, creating a high density power plant with least copper mass as low as ½ of a two phase stator and ⅔ of a three-phase stator.

6. The electric fuel pump for an internal combustion engine according to claim 1, comprising at least one serviceable inlet (primary) filter which conforms to the long life of a brushless dc fuel pump by being changeable or washable when blocked by debris.

7. The electric fuel pump for an internal combustion engine according to claim 6, comprising at least one unserviceable secondary filter, downstream of the serviceable primary filter, impossible to temper by any means, to hold any debris which may accidentally make its way beyond said primary filter barrier during filter changes thus creating an invincible secondary barrier to protect the pump mechanism and fuel system components.

8. The electric fuel pump for an internal combustion engine according to claim 1, comprising at least one torsional spring coupling rotatably connecting the magnetic rotor with the pump rotor to give the magnetic rotor a certain amount of angular backlash so that the magnetic rotor can start against a lower torque under severe conditions such as cold fuel or trapped foreign material inside the pump mechanism that requires a higher torque to overcome.

9. The electric fuel pump for an internal combustion engine according to claim 8, wherein said torsional spring coupling can be made from variety of materials.

10. The electric fuel pump for an internal combustion engine according to claim 1, comprising at least one protrusion on a stator end insulator of the driving assembly and at least one indentation on a spacer of the driven assembly to make sure that the two subassemblies are assembled concentrically forming a uniform air gap between stator and rotor and the torque between the driving and driven subassemblies is taken up.

11. The electric fuel pump for an internal combustion engine according to claim 1, comprising at least one indentation on a stator end insulator of the driving assembly and at least one protrusion on a spacer of the driven assembly to make sure that the two subassemblies are assembled concentrically forming a uniform air gap between the stator and the rotor and that the torque between the driving and driven subassemblies is taken up.

12. The electric fuel pump for an internal combustion engine according to claim 10, comprising a shaft extension on the fixed shaft and a hole on a centring to allow the two subassemblies to be assembled concentrically forming said uniform air gap between the stator and the rotor.

13. The electric fuel pump for an internal combustion engine according to claim 1, that said rotor is overmoulded with an engineering plastic which has no protrusions or indentations on the outside forming an egg-like rotary part.

14. The electric fuel pump for an internal combustion engine according to claim 11, comprising a shaft extension on the fixed shaft and a hole on a centring to allow the two subassemblies to be assembled concentrically forming said uniform air gap between the stator and the rotor.
